(19) United States
(12) Patent Application Publication
(10) Pub. No.: US 2011/0291345 A1
(43) Pub. Date: Dec. 1, 2011

(54) METHOD FOR PRODUCING A PRINTED PRODUCT

(75) Inventor: Guenther Silberbauer, Uerkheim (CH)

(73) Assignee: Mueller Martini Holding AG, Hergiswil (CH)

(21) Appl. No.: 13/116,545

(22) Filed: May 26, 2011

(30) Foreign Application Priority Data
May 26, 2010 (CH) 00825/10

(51) Int. Cl. B65H 39/00; B41F 13/68

(52) U.S. Cl. 270/52.19; 270/58.07

(57) ABSTRACT

A method and apparatus are provided for producing a printed product composed of at least one signature and at least one extra sheet. The signatures and extra sheets are supplied in different product flows to a transfer device having gaps for receiving the signatures and extra sheets. The transfer device is arranged between a first product flow of the signatures and at least a second product flow of the extra sheets, on the one hand, and at least one stacking device, on the other hand. The cadence of the gaps which accommodate the extra sheets is controlled with the use of a control coupled to the transfer device.

### CROSS-REFERENCE TO RELATED APPLICATION

This application claims the priority of Swiss Patent Application with No. 00825/10, filed on May 26, 2010, the subject matter of which is incorporated herein by reference.

### BACKGROUND OF THE INVENTION

The present invention relates to a method for producing a printed product composed of at least one signature and at least one extra sheet, and wherein the signatures and the extra sheets are supplied in different product flows. The invention furthermore relates to a transfer device for realizing a method of this type.

A method for producing printed products, such as books, booklets, magazines or the like, is known from the European patent document EP 1 559 573 A1. According to this method, sheets printed in a printing press are respectively folded in a folding device, are then conveyed to a stacking device and are stacked therein to form a book block. At least one extra sheet or insert is added to the individual printed sheet or signature and the combined product, composed of the printed sheet and the extra sheet, is then conveyed further and stacked. The extra sheet is thus added to an individual signature and the product composed of signature and extra sheet is subsequently stacked in the same general manner as other signatures or printed sheets to form a book block. The aforementioned extra sheets can involve illustrations or colored pictures. The extra sheets may also refer to printed sheets composed of a special type of paper. The extra sheets can furthermore be functional sheets which are effectively inserted during a post-processing operation, such as the fly leaves for hardcover books. The book block with the inserted extra sheet can then be processed in the standard manner, for example through adhesive binding, trimming, and the like, wherein several extra sheets can also be inserted without a problem. This prior art document furthermore discloses that the extra sheet can be pulled with the aid of a feeder from a stack and can subsequently be added to the individual signature. It is furthermore possible to guide the extra sheet to a second conveying device where it is combined with an individual signature conveyed sequentially in a conveying device. In the process, the second conveying device is preferably supplied with the aid of a feeder. If several different extra sheets are to be made available, several feeders must be used which respectively deliver one extra sheet to this second conveying device. As a result, a book block can be formed which comprises several different extra sheets, wherein these extra sheets can furthermore be inserted at different locations into the book block. However, each extra sheet is always added to a single signature.

The system as described in the prior art reaches its limits, however, with respect to position accuracy and output rate if book blocks must be formed for which the extra sheets are added at irregular intervals and not in the same sequence, or if several extra sheets must follow successively, or if the extra sheets are embodied at least in part as printed sheets. To be sure, improvements in some points are possible, but these improvements always involve a relatively large expenditure.

### SUMMARY OF THE INVENTION

An object of the invention is to remedy the above described problem. The invention thus relates to the problem defined for a method and a device of the aforementioned type of dividing in a controlled manner a flow of printed products, such that it is possible to place inserts and/or extra sheets into interstices or gaps which are clocked according to a predetermined cadence. It is furthermore an object of the present invention to subsequently permit a consistent stacking of the aforementioned sheets or signatures to form a book block.

The above and other objects are achieved according to the invention with a method for producing a printed product composed of at least one signature and at least one extra sheet, the method comprising supplying the signatures and the extra sheets in different product flows to a transfer device having gaps for receiving the signatures and extra sheets, the transfer device being arranged between a first product flow of the signatures and at least a second product flow of the extra sheets, on the one hand, and at least one stacking device, on the other hand; and predetermining a cadence of the gaps which accommodate the extra sheets with the use of a control coupled to the transfer device.

The transfer device comprises spaced-apart gaps or holding locations which are operatively tied to the clocking of the conveying speed for the individually supplied signatures and extra sheets, thus ensuring a continuous conveying operation. The individually supplied signatures and extra sheets are inserted purposely, with a predetermined cadence, into the individual gaps or holding locations of the transfer device.

The signatures and sheets are actually transported along a specific arc angle or along a specific section, depending on the design of the transfer device. When using such a conveying device, the extra sheets can easily be deposited in a non-monotonous cadence into the gaps in the transfer device and can be added without problem to previously deposited sheets, wherein this maximizes the flexibility of the method according to the invention.

An advantage of the invention is that the feeding and inserting of illustrations or the like into a printed product, for example into a book block or book, can be realized easily and flexibly. The signatures supplied in a flow, which essentially represent the actual content of the printed product, are thus initially transferred to a transfer device, wherein the cadence of the signatures and extra sheets supplied during the operation of the transfer device is operatively tied to the conveying speed of the transfer device. Thus, it follows that the cadence of the supplied signatures or the conveying speed of the transfer device can be selected individually, such that cadences can be missed to provide locations for the subsequently added extra sheets. An operative connection of this type between the individual operating speeds can advantageously be achieved when using a super-imposed adaptive control or regulation.

Another advantage of the invention is that the conveying system can be expanded in the area surrounding the transfer device by using a circulating chain with grippers (see also European document EP 1 312 568 concerning the technical environment). Seen this way, each second gripper can be provided with a signature, wherein an extra sheet from a different product flow can be supplied to the position-relevant gripper either before or after, such that the aforementioned sheets and signatures can all be removed in a following processing step from the transfer device and can be stacked to form book blocks. A method structured in this way has the advantageous aspects of permitting extremely high speeds during the insertion operation, wherein these high speeds simultaneously allow an online printing of the signatures as well as the extra sheets which are supplied in the product flows.

A further advantage of the invention is that the signatures and, if applicable, also the extra sheets can be produced with respect to content starting with a digital printing press, wherein the signatures and extra sheets can also be printed sequentially. If a product is printed sequentially it means that the digital printer starts with the first page of the printed product and then immediately prints all successively following pages, required to complete the printed product. Digital printers operate without a fixed print form and can therefore operate in the aforementioned manner.

According to another aspect of the invention, there is provided an apparatus for producing a printed product composed of at least one signature and at least one extra sheet, which in one embodiment comprises: conveyors to supply the signatures and the extra sheets in respectively different first and second conveying flows; at least one stacking device to stack the printed products; at least one transfer device arranged between at least the first product flow of the signatures and at least a second product flow of extra sheets, on the one hand, and the at least one stacking device on the other hand, wherein the transfer device has gaps into which the signatures and extra sheets are insertable; and a control coupled to the transfer device to determine a cadence of the gaps for accommodating the extra sheets.

According to one a further embodiment, the transfer device may be embodied as a star-shaped intake device provided with blades, also called a fan wheel, wherein this fan wheel accommodates the supplied signatures and/or extra sheets in the gaps created for this. The rotary movement of the fan wheel conveys the signatures further over a specific arc angle and along at least one plane to a location where they are subsequently stacked into a book block. The elements of the intake fan wheel can be embodied either straight or with a blade-type, curved geometry.

According to another embodiment, the transfer device may include a continuously circulating conveying chain provided with pocket-type holding locations, arranged at a distance to each other, for accommodating the signatures and the extra sheets for the further transport. The stacking of the signatures may take place during a first change in direction of the transport chain. The gaps, respectively the pocket-type holding locations, can be supplemented if necessary with individual holding devices which secure the individual signatures in a stable position, least during the transport.

Another advantage of the invention concerns the different methods for transporting the signatures and the extra sheets along the respective conveying path. They can be conveyed individually and spaced apart or in a scaled or overlapping flow and, in addition, can respectively be characterized by one or several folding operations that occur upstream of the transfer device. These folding operations, which advantageously always occur upstream of the transfer device, preferably can also follow an earlier separating operation. These separating operations can be executed in a longitudinal or lateral direction, relative to the printed-on paper web, thereby resulting in high flexibility for the method.

The signatures or printed sheets and, if applicable, also the extra sheets may be processed with a simple folding operation. However, several folding operations which increase the stiffness of the signature can also be realized without problem, wherein the excess folding edges can be trimmed to format size after the stacking operation and any further processing that may take place.

### BRIEF DESCRIPTION OF THE DRAWINGS

These and other features and advantages of the invention will be further understood from the following detailed description of the preferred embodiments with reference to the accompanying drawings.

FIG. 1 is a perspective view of a system for transporting at least one signature and extra sheet with the aid of a rotating transfer device.

FIG. 2 is a perspective view of a system for transporting at least one signature and extra sheet with the aid of a conveying belt.

### DETAILED DESCRIPTION

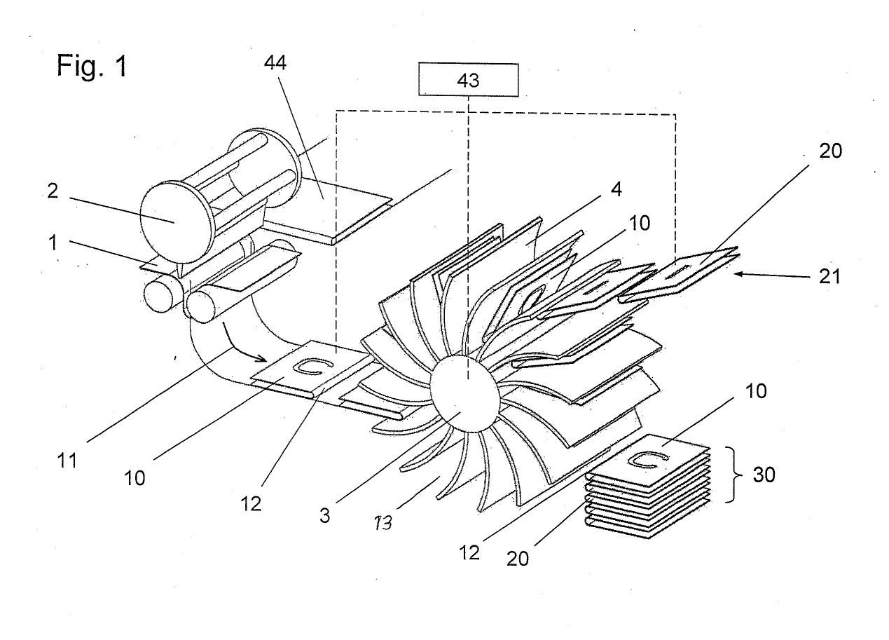

Referring to FIG. 1, there is shown a folding device 2 to fold a sheet 1 to produce a folded signature 10 that is transported in a first product flow 11 to a transfer device 3 that comprises a fan wheel with blade-type holders forming pockets or gaps 13. Extra sheets 20 are supplied on the other side of transfer device 3 via a separate product flow 21, wherein these extra sheets are inserted into gaps 13 defined by the separating elements or blades 4 of the fan wheel, which is controlled by a control 43. The transfer device 3, which is embodied as a fan wheel, further conveys the supplied signatures and extra sheets positioned in the gaps 13 over a specific arc angle, so that these signatures and extra sheets leave the gaps 13 or are ejected from the respective gaps at a specified location and are stacked immediately thereafter at a stacking location 30. The stacking thus is congruent with the sequence of the signatures and extra sheets which are continuously gathered within the transfer device 3.

FIG. 1 discloses that individually cut sheets 1 are folded in a lateral direction in the folding device 2, so as to form a signature 10, wherein the supplied sheet 44 may already have one or several scored lines for the folding. Of course, the signatures 10 and the extra sheets 20 can also be printed as individual sheets. The representation according to FIG. 1 in this case refers to a folding device which is configured such that the back fold 12 of the signature 10 is leading in the direction of the first product flow 11 as shown by the arrow in FIG. 1, so that it can be easily inserted into and positioned in the associated gap 13. The same is true for the extra sheets 20 which are supplied with the aid of a second product flow 21, wherein these can also be folded easily at least once and ahead of time. Nevertheless, it does not mean that having a back fold that is facing in the forward movement direction represents a required step in the transport sequence. Of course, the signatures 10 or the extra sheets 20 can also be supplied with the opened side facing in the forward movement direction. Following the movement at an angle of approximately 180°, the signatures 10 are released and/or ejected from the gaps 13, wherein the respective back fold 12 is trailing, meaning it occupies the same position, relative to the book block, as it did upstream of the transfer device. The folded signature 10 in that case has one or several openings in the front, relative to the stack 30. The same is also true with respect to the back fold 12 for the extra sheets 20, provided such a fold is realized. These extra sheets temporarily occupy the free cadences between the gaps 13 not occupied by the signatures 10 in the fan wheel, wherein the latter are transported over an arc angle, meaning a rotary or quasi-rotary translation, of approximately 90°.

A one-time folding can already result in a high, stabilizing stiffness for the transport of the signatures and the extra sheets, thus ensuring a more secure positioning during the following stacking operation 30, wherein we refer to the explanations below for this. The extra sheets 20, however, need not exclusively occupy only individual free gaps 13, but they can also be inserted easily into the open side of each folded signature 10, depending on the composition of the book block, wherein opening devices may be provided in that case. The insertion into the open side makes sense, in particular, if the extra sheet in the book block must meet the function of an insert.

The flexibility of the system is thus obvious since the same transfer device 3 can be used without problem to supply additional and/or different inserts or extra sheets to the product flows. As will be explained in further detail later on, the fan-type division of this transfer device 3 comprises individual blade-type elements 4 which have a concave curvature in the rotational direction and, in particular, move counter to the centrifugal forces generated in the rotational direction. The concave curvature on the inside of the blade-type elements 4 therefore increases the centripetal force generated by the material mass of the transported signatures, so that the signatures remain in a stable position during the transport, even at high rotational speeds. The curvature of the blade-type elements changes its affinity in the stacking region, thus making it easier for the signatures in the stacking region to slide out of the gap 13 via the convex surface of the blade-type element. A curvature of this type also ensures a movement-conform transfer of the signatures to the stacking location, in particular if the dynamic transfer is realized such that the signatures to be deposited are ejected with the fronts facing in the movement direction and are successively deposited as a result of the rotation. A print-related stabilizing effect is therefore generated for the arriving sheet, relative to the preceding sheet, wherein this stabilizing effect is particularly important if the stacking operation is intermittent and/or on the fly. The fan wheel elements 4 do not necessarily have to be embodied as blades since they primarily function to separate the individual signatures 10 from the extra sheets 20, as well as to form the pocket-type gap for holding additional sheets 20, wherein this gap is determined continuously and adaptively by the control 43. The control consequently determines the cadence of the gaps 13 which can be inserted with an extra sheet according to a monotonous cadence, for example either after each signature or after respectively two successively conveyed signatures and the like. Sequences can furthermore be provided where the gaps are inserted according to irregular arithmetic or based on geometric number series.

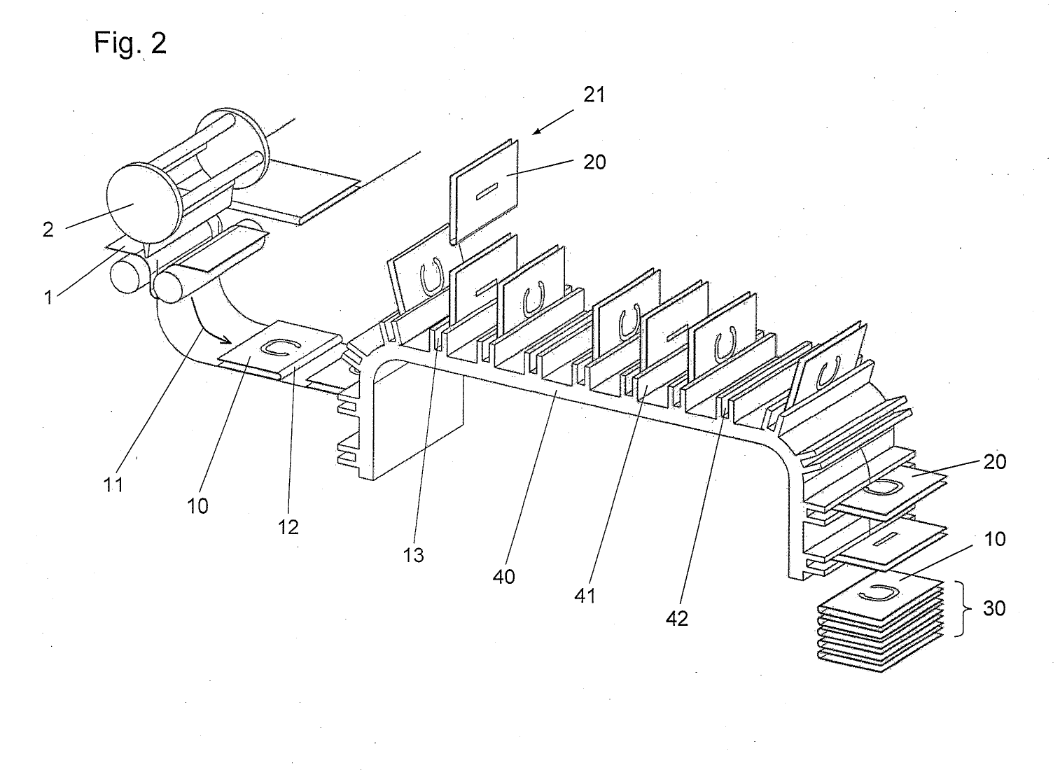

FIG. 2 illustrates a different transfer device 40 in the form of a transport chain. This endlessly circulating transport chain 40, shown for the sake of simplicity in an open view in FIG. 2, is provided with spaced-apart channels 41 which are open at the top and function as pocket-type holding locations for holding the signatures and are designed for continuously accepting and transporting signatures 10 and extra sheets 20. The channels 41 can also be embodied as clamps which exert a holding force onto the printed product. The opening width of the open slit or gap 42 is dimensioned such that the aforementioned signatures and sheets 10, 20 can be inserted easily during the feeding operation, to allow a position-stable transport of the signatures and sheets during the translatory movement, and so that the signatures and sheets can be ejected easily in the stacking region. The design of this holding location is consequently extremely important because of the different functions it must meet. Since the clocking speeds are extremely high, centrifugal forces and fluttering movements as well as other interferences can automatically develop and could slightly exceed the capacity of the folded signatures to remain in place, which is based on the rigidity. This narrow layout of the holding location is an essential component of the transfer device, not least because the extra sheets can also be individual, non-folded sheets.

The flexibility of the system is maximized only if the holding locations can continuously accept and securely transport optional signatures and optional extra sheets. On the other hand, it is correct to say that the sheets 20 in particular should not be clamped too tightly into the slits 42 since this could substantially obstruct the ejection of the sheets in the stacking region 30, thereby causing disruptions in the process and resulting in an incorrect stack formation. The system according to FIG. 2 also uses a control, not shown herein, which is embodied similar to the one shown in FIG. 1.

For this embodiment, the control also determines the cadence of the gaps, meaning a monotonous cadence can be used for inserting the gaps with an extra sheet after each signature or respectively following two successively conveyed signatures and the like. However, sequences can also be used to insert gaps based on irregular arithmetic or based on geometric number series.

In principle, the above-described transfer devices 3, 40 are designed such that the negative forces generated during a high-capacity transport of the signatures and extra sheets and during the subsequent stacking operation, such as centrifugal forces generated by the star-shaped transfer device 3, cannot negatively influence the stacking operation. Folded signatures in general have an extremely high form stability which advantageously effects the reliable and precise stacking.

It will be understood that the above description the present invention is susceptible to various modifications, changes and adaptations, and the same are intended to be comprehended within the meaning and range of equivalents of the appended claim.

What is claimed is:

1. A method for producing a printed product composed of at least one signature and at least one extra sheet, the method comprising:
supplying the signatures and the extra sheets in different product flows to a transfer device having gaps for receiving the signatures and extra sheets, the transfer device being arranged between a first product flow of the signatures and at least a second product flow of the extra sheets, on the one hand, and at least one stacking device, on the other hand; and
predetermining a cadence of the gaps which accommodate the extra sheets with the use of a control coupled to the transfer device.

2. The method according to claim 1, wherein the predetermining step includes using the control to clock the cadence of the gaps for accommodating the extra sheets, relative to the supplied signatures.

3. The method according to claim 2, including making the insertions of the extra sheets, relative to the supplied signatures, into the gaps according to a monotonous, simple or multiple cadence, or clocked sequences for which the gaps are inserted according to regular or irregular arithmetic and/or a geometric number series.

4. The method according to claim 1, wherein the supplying step includes transporting the signatures and extra sheets respectively in at least one product flow, and either individually and spaced-apart, or in a scaled flow.

5. The method according to claim 1, including embodying the transfer device as a fan wheel having blades in which the gaps are defined between the blades and wherein the supplying step includes accommodating the supplied signatures and extra sheets in the gaps according to the predetermined cadence, and the method includes further conveying the signatures and extra sheets with a rotary or quasi-rotary movement of the transfer device over an angle of circumference and within at least one plane.

6. The method according to claim 5, wherein blades of the fan wheel comprise separating elements arranged in circumferential direction and spaced-apart relative to each other.

7. The method according to claim 6, wherein the separating elements are one of a) straight elements or b) blade-type curved elements having an inside surface with a concave shaped in the rotational direction.

8. The method according to claim 5, including operating the rotational movement of the fan wheel uniformly, adaptively based on movement profiles, or in dependence on speeds of the product flows.

9. The method according to claim 1, including embodying the transfer device as an endlessly circulating conveying chain with spaced-apart holding locations, and wherein the supplying step includes inserting the signatures and extra sheets at the holding locations, and the method further includes conveying the sheets further along at least one conveying plane with a substantially translatory movement.

10. The method according to claim 9, including operating translatory movement of the conveying chain uniformly, adaptively based on movement profiles, or in dependence on the speeds of the product flows.

11. The method according to claim 1, further including folding at least one of the signatures and the at least one extra sheet one or multiple times, respectively, upstream of the transfer device.

12. The method according to claim 1, wherein the supplying step is performed so that with a concordant direction between the movement of the transfer device and the movement for conveying the signatures and the extra sheets to the transfer device, a relative speed of the two movements tends toward zero during transfer of the signatures and the extra sheets to the transfer device.

13. The method according to claim 10, including changing the speeds of the movements of the product flows relative to each other adaptively or adaptively based on movement profiles.

14. The method according to claim 1, wherein the supplying step includes conveying the signatures and the extra sheets in the respective product flows either individually and spaced apart, or in a scaled flow.

15. An apparatus for producing a printed product composed of at least one signature and at least one extra sheet, comprising;
conveyors to supply the signatures and the extra sheets in respectively different first and second conveying flows;
at least stacking device to stack the printed products; and
at least one transfer device arranged between at least the first product flow of the signatures and at least a second product flow of extra sheets, on the one hand, and the at least one stacking device on the other hand, wherein the transfer device comprises a fan wheel including separating elements arranged in a circumferential direction at a distance to each other defining gaps into which the signatures and extra sheets are insertable.

16. The apparatus according to claim 15, wherein the separating elements are one of a) straight elements or b) blade-type curved elements each having an inside surface of that is concave in a rotational direction.

17. An apparatus for producing a printed product composed of at least one signature and at least one extra sheet, comprising;
conveyors to supply the signatures and the extra sheets in respectively different first and second conveying flows;
at least stacking device to stack the printed products; and
at least one transfer device arranged between at least the first product flow of the signatures and at least a second product flow of extra sheets, on the one hand, and the at least one stacking device on the other hand, wherein the transfer device comprises as an endlessly circulating conveying chain having spaced-apart holding locations, wherein the supplied signatures and/or extra sheets are insertable into the holding locations.

18. The apparatus according to claim 17, wherein the holding locations comprise clamps.

19. An apparatus for producing a printed product composed of at least one signature and at least one extra sheet, comprising;
conveyors to supply the signatures and the extra sheets in respectively different first and second conveying flows;
at least stacking device to stack the printed products;
at least one transfer device arranged between at least the first product flow of the signatures and at least a second product flow of extra sheets, on the one hand, and the at least one stacking device on the other hand, wherein the transfer device has gaps into which the signatures and extra sheets are insertable; and
a control coupled to the transfer device to determine a cadence of the gaps for accommodating the extra sheets.
